(19) United States
(12) Patent Application Publication
(10) Pub. No.: US 2009/0024596 A1
(43) Pub. Date: Jan. 22, 2009

(54) SYSTEM AND APPARATUS TO REPRESENT, STORE, MANIPULATE, AND PROCESS METADATA INFORMATION

(75) Inventors: Andrea BASSO, Marlboro, NJ (US); David Crawford GIBBON, Lincroft, NJ (US)

Correspondence Address: AT&T CORP., ROOM 2A207, ONE AT&T WAY, BEDMINSTER, NJ, 07921, US

(73) Assignee: AT&T Labs, Inc., Austin, TX (US)

(21) Appl. No.: 11/929,690

(22) Filed: Oct. 30, 2007

Related U.S. Application Data
(60) Provisional application No. 60/950,381, filed on Jul. 18, 2007.

(51) Int. Cl. G06F 17/30

(52) U.S. Cl. 707/4

(57) ABSTRACT

Disclosed herein are systems, methods, and computer-readable media to represent, store, and manipulate metadata. The method for representing metadata includes defining a map to metadata stored in a global database for each of a plurality of metadata containers, receiving a query for metadata associated with a file, determining which of the plurality of metadata containers the query requires, and responding to the query based on metadata associated with the file from the global database retrieved using the corresponding map for the determined metadata container. The method for storing metadata includes defining a map for metadata to be stored in a global database for each of a plurality of metadata containers, receiving information to be entered as metadata associated with a file, determining which of the plurality of metadata containers is compatible with the received information, and storing the information in the global database associated with the respective file using the corresponding map for the determined metadata container. Other methods relate to manipulating the metadata.

### PRIORITY CLAIM

The present application claims the benefit of U.S. Provisional Application No. 60/950,381, filed Jul. 18, 2007, the contents of which is incorporated herein by reference in its entirety.

### BACKGROUND OF THE INVENTION

1. Field of the Invention

The present invention relates generally to metadata storage manipulation and retrieval, and, more specifically, to metadata storage in a global database and metadata retrieval in multiple metadata formats or views.

2. Introduction

Metadata is a critical element in automated content management, handling, and organization. Metadata is information about the content of the files. Metadata needs vary widely between various file types and even between different uses for the same file types. For example, a content provider may need to store bibliographical information about a file, such as author, title, creation date, etc. A service provider may need to store a content description, ASR and alignment, available output formats, etc. A network provider may need to store latency, throughput, billing and accounting information, etc. An end-user may need to store user ratings, preferences, personal notes, etc. Some broad categories of metadata include standard attributes derived from context or structural metadata (i.e. author.name, media.id, file.name, period, or genre), descriptive terms (i.e. title, description, summary, abstract, or short plot), media intrinsic features (faces, speakers, or content-based sampling), function specific elements (for video delivery, bitrate or format; for e-commerce, shipping location or distribution; etc).

Several approaches exist to storing metadata. Metadata may be stored as an internal part of the file itself, such as an ID3 tag in an MP3 file, metadata may be stored as a separate, external file, such as an XML file or relational database, or metadata may be stored as a blend of both.

Several problems exist with these varied sets of needs and approaches to how and where metadata is stored. First, comprehensive, efficient searches are difficult or impossible because metadata may be spread out over many locations and many formats. A searcher has no way of knowing if a given set of metadata is a complete set. Metadata standards are divergent and evolving, further complicating the problem. Second, with metadata stored in multiple places, redundancy can occur and waste storage space. For example, an audio file may attempt to store every major metadata format within the file, thereby greatly increasing the file size without adding significant new information. While in some cases, the redundancy may be “only” a couple hundred kilobits or more, this redundancy, when summed across tens or hundreds of thousands of files, translates to significant wasted storage space. The problem of wasted storage space may be even more significant if it is considered in a global context where a given file may reside on tens of millions of personal computers, digital audio players, or other devices. Third, unnecessary redundancy can lead to data synchronization problems. If multiple copies of the same metadata are stored in different formats, and one is changed, there is no mechanism to update the information and keep metadata synchronized between formats. This may lead to inconsistencies in the data. Resolving multiple metadata inconsistencies across multiple files quickly becomes an unmanageable task.

Accordingly, what is needed in the art is a centralized way to store metadata associated with a file, retrieve metadata in various formats as needed, and modify the central store of metadata.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

The present invention relates to improving metadata representation, storage, and manipulation. Disclosed are systems, methods, and computer-readable media for metadata representation, storage, and manipulation. The method for representing metadata includes defining a map to metadata stored in a global database for each of a plurality of metadata containers, receiving a query for metadata associated with a file, determining which of the plurality of metadata containers the query requires, and responding to the query based on metadata associated with the file from the global database retrieved using the corresponding map for the determined metadata container. The method for storing metadata includes defining a map for metadata to be stored in a global database for each of a plurality of metadata containers, receiving information to be entered as metadata associated with a file, determining which of the plurality of metadata containers is compatible with the received information, and storing the information in the global database associated with the respective file using the corresponding map for the determined metadata container. In case no mapping is found, a new metadata container is created containing the received metadata information. The method for manipulating metadata includes defining a map to metadata stored in a global database for each of a plurality of metadata containers, receiving a request to manipulate metadata associated with a file, determining which of the plurality of metadata containers the request is associated with, and manipulating the metadata associated with the file in the global database as requested using the corresponding map for the determined metadata container.

Some typical example implementations of the invention include a digital video/audio player, cable or satellite television system, computer, or other device, system, or method that interacts with at least one file potentially containing metadata. As an example, a cable or satellite television system broadcasts programming originating from a variety of sources. Each source may embed metadata in the audiovisual signal in a different metadata format. A cable or satellite television provider could use different metadata containers representing different views of metadata to extract metadata from each signal in its own format and re-encode the same information in the video signal in a unified, consistent metadata format for ease of television receiver implementation or other goals.

Another example is a media player that may generate a separate file that contains all the metadata for available media files and also contains the various views for possible metadata formats. In this way, no matter in what metadata format a medium's metadata is queried or searched, the media player only needs to perform one file open instead of potentially tens of thousands. The file containing all the metadata could even be stored in a cache to decrease response time if constant reading or writing is desired.

The invention may be implemented and/or performed on one or more clients, one or more servers, or a blend of both. Metadata containers can be database fields including XLM fields or links to external database references making the metadata representation completely distributed across data networks. The invention may be embodied as an intermediary black box or service that resides between a client and server, a client and a file, server and a file, etc.

In some cases, the invention may even be wholly self-contained in the file the metadata describes. For example, an audio file could contain a section holding all the metadata about the file, and have separate sections within the file for different formats of metadata (such as ID3, Vorbis Comments, and APE), the fields of each different format merely holding a pointer or similar structure that references back to the section storing all the metadata.

This may be termed a hierarchical multi-view model. A single global view contains all the metadata about a file, which feeds information to one or more views. A subset of metadata may be provided for each metadata format.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a basic system or computing device embodiment of the invention;

FIG. 2 illustrates a map of metadata to a database;

FIG. 3 illustrates a system for representing, storing, or manipulating metadata;

FIG. 4 illustrates a method embodiment for representing metadata;

FIG. 5 illustrates a method embodiment for storing metadata; and

FIG. 6 illustrates a method embodiment for manipulating metadata.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

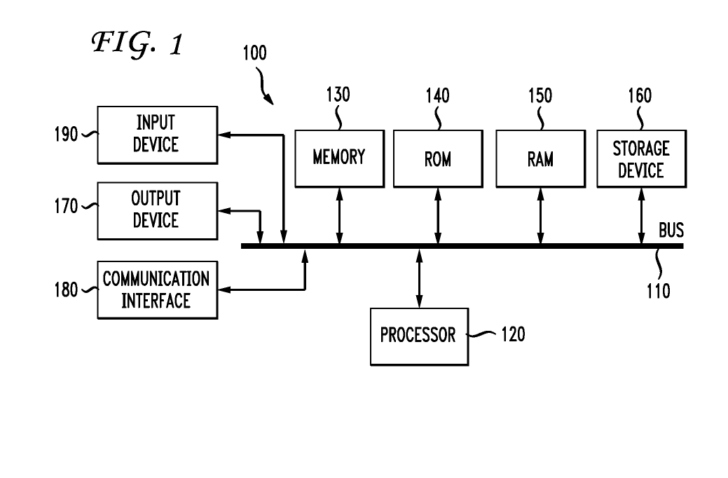

With reference to FIG. 1, an exemplary system for implementing the invention includes a general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus I 10 may be any of several types of bus structures including a memory bus or memory controller, a peripheral bus, and a local bus using any of a variety of bus architectures. A basic input/output (BIOS), containing the basic routine that helps to transfer information between elements within the computing device 100, such as during start-up, is typically stored in ROM 140. The computing device 100 further includes storage mechanisms such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, or a computer server.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The input may be used by the presenter to indicate the beginning of a speech search query. The device output 170 can also be one or more of a number of output mechanisms. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative embodiment of the present invention is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

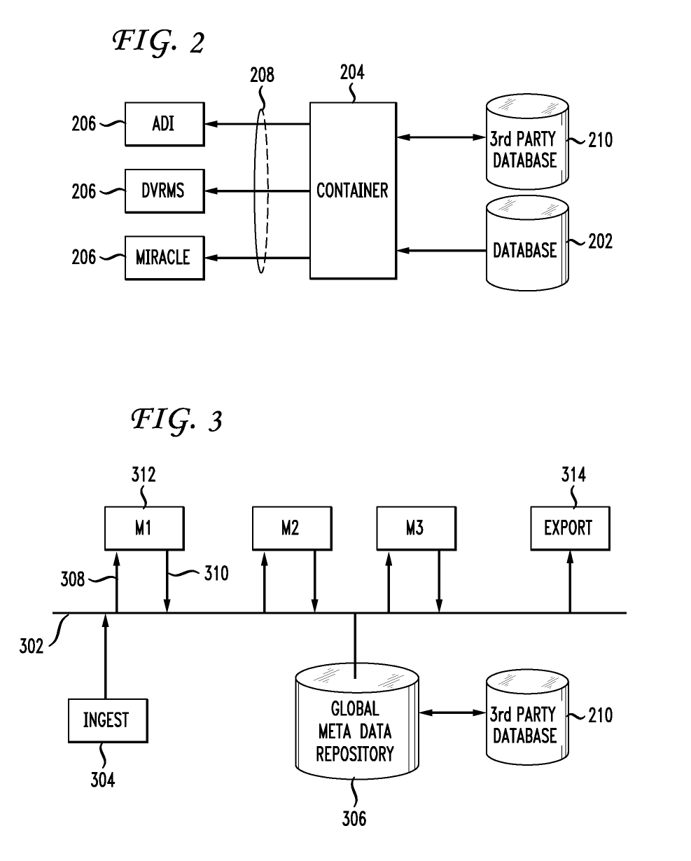

FIG. 2 demonstrates an example map of metadata to a database. Metadata about one or more files is stored in a database of metadata 202. The database may be any suitable database, including a flat file database, relational database, or XML database. The database may be stored as part of the file it contains information about, or the database may be stored as a separate file. The database may contain metadata associated with more than one file. Metadata from the database 202 may be accessed through a container 204 as requested for a particular file. Only necessary metadata may be pulled in to the container. From the container, pointers 208 to fields may map individual pieces of metadata to particular metadata views 206, such as Asset Distribution Interface (ADI), Digital Video Recording-Microsoft (DVR-MS), or Miracle. Pointers and their applicable variations are known in the art; further discussion here is unnecessary. Different views may consist of various subsets of the metadata (view c metadata) or may even contain the all the metadata available for a given file (view c metadata).

Views may be dynamically generated. Dynamically generated views may be used to accommodate rarely accessed metadata views, metadata views not yet contemplated, custom user-generated metadata views, etc. As many views as necessary may be used to accommodate various metadata formats.

Also shown in FIG. 2 is a link from container 204 to a third-party database 210. This illustrates an aspect of the invention related to the distributed nature of the representation of the metadata. For example, the container 204 can include links to third-party databases. There are two distinct situations where this may arise. First, where metadata is physically ingested (i.e., a file is read and stored) in the system and a container is created for it. An example may be using a template for a particular metadata format such as CableLabs ADI, MPEG-7 or MPEG-21. Next, metadata may be in given format and is ingested but instead of being stored locally, it is stored in a third party database (such as a recommendation engine or perhaps the metadata is encrypted). In this case, the container consists of a description of the format (i.e., MPEG-21) and a link to the database is provided.

FIG. 3 illustrates an example system for representing, storing, and manipulating metadata. The metadata bus 302 connects all the other components. The metadata bus can ingest (receive) 304 metadata information associated with a file and transmit it to the global metadata repository 306 for storage. The metadata repository may contain metadata about one file or about many files, if it is capable of differentiating between metadata about multiple files. A third-party database 210 is also shows metadata repository 306 may contain links to third-party databases such as database 210. Various metadata views 312 are attached to the metadata bus 302. Metadata views may be predefined or calculated on the fly. Each metadata view is attached to the metadata bus by a reader 308 and a writer 310. The reader 308 for each metadata view 312 traverses the metadata bus 302 to retrieve the metadata from the global metadata repository 306. In this manner, traditional requests for metadata (such as a digital audio player requesting metadata about an MP3 file) can interface with a corresponding metadata view 312, which next interfaces with the global metadata repository 306. In a similar fashion, traditional requests to update, modify, or delete metadata are routed through an interface view 312, through the writer 310, across the metadata bus 302, to the global metadata repository 306 where the information is centrally updated. In this way, information is synchronized or automatically updated across all metadata views because they all draw from the global metadata repository for metadata. All or part of the global metadata repository 306 may be exported 314 for archival, backup, comparison, or other purposes.

This may be termed a hierarchical multi-view model. A single global view (the global metadata repository) contains all the metadata about a file or about multiple files, which feeds information to one or more views. One semi-complete view is provided for each metadata format. Each individual view may be statically mapped or dynamically mapped on demand. Dynamically mapped views are more likely to be proprietary for a particular application or likely to be provided by customers in the form of ratings, personal feedback, or notes. Each static view may be stored in the global metadata repository.

The tradeoff between storage and processing power between static and dynamic views is that dynamic views require little storage, but are somewhat more computationally expensive, whereas static views require more storage than dynamic, but are computationally inexpensive. A blend of static and dynamic may be used to optimize desired performance. Each view may be designed to be a plugin, where only necessary views are installed or activated.

One benefit of this method is maintaining integrity and consistency of metadata through multiple additions, changes, or updates to the metadata, because all metadata is stored in and retrieved from a central location. Another benefit is that metadata may be encrypted, as the metadata bus does not necessarily process the metadata, it allows metadata to cross transparently. Encrypted metadata may be returned blindly to the requester, or encrypted metadata may be placed in the global metadata repository. All the metadata may be encrypted, if security is an important consideration, such as when customer information is embedded in metadata. Another benefit is flexibility and modularity. When new metadata formats are established, all that needs to be done is generate a new view and determine how the new view is mapped to the metadata in the central location. Flexibility to allow for future standards is a welcome benefit in almost any computer implementation. Alternative output mechanisms could also be easily accommodated.

In one aspect, it is not mandatory that the containers are created in advance. For example, if a given metadata representation does not map to any existing container, a new contains or other structure may be created as well as its associated mappers. Thus, there is a dynamic and flexible nature to this approach.

This method can also benefit the speed of metadata queries, because querying one central location is likely to be faster than sending multiple queries to multiple sources and waiting for the slowest one. Another benefit is no loss of data. When metadata is mapped to different views, the translation is transparent. No information is altered; it is just mapped with different groups of metadata to form a different format for each view. Redundancy is limited to approximately ten to twenty kilobits per asset. As stated before, while a savings of tens of kilobits may seem insignificant, the savings multiplied across hundreds of thousands of files has tremendous space-saving potential.

Mapping between the views and the global metadata repository may be based on several factors. Mapping might be based on rules or on a rule-based engine, for more flexibility. Rule-based engines would allow for optimum flexibility at the cost of incrementally increased computation time. Mappers might be implemented as plugins, similar to how views may be plugins. Yet another potential benefit from this invention is that existing content management systems and business processes do not need to change, because different views and mappers may be used as plugins to allow legacy systems to interact with the global metadata repository as if the metadata were stored in formats that may have been deprecated or are no longer in widespread use.

For example, this aspect of maintaining metadata allows for a “lossless” representation of the metadata. This occurs because the metadata created and associated with a given dataset is never deleted, it is always preserved.

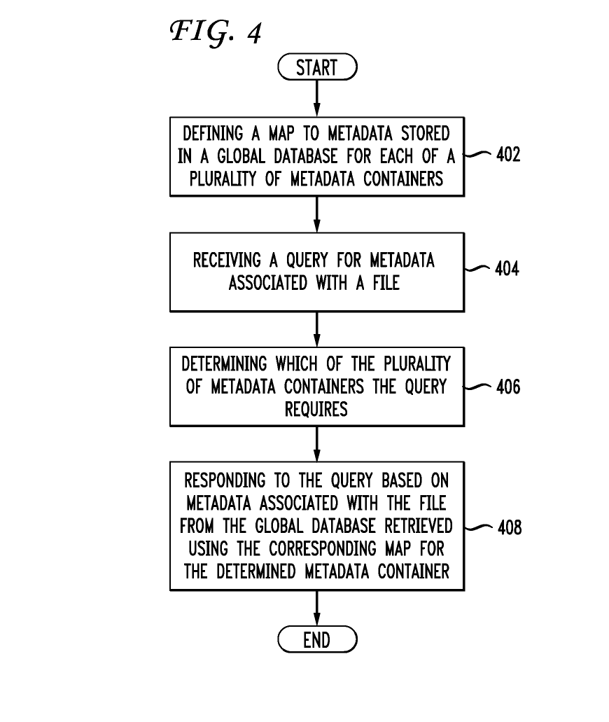

FIG. 4 illustrates a method for representing metadata. First, the method defines a map to metadata stored in a global database for each of a plurality of metadata containers (402). Each map may be either defined statically in advance, or defined dynamically as needed. Second the method receives a query for metadata (404). Third, the method determines which of the plurality of metadata containers the query requires (406). Finally, the method responds to the query with metadata from the global database retrieved using the corresponding map for the determined metadata container (408).

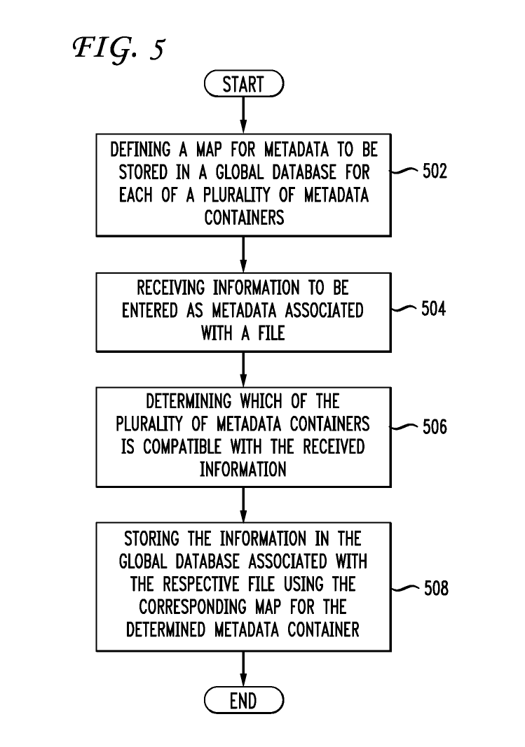

FIG. 5 illustrates a method for storing metadata. First, the method defines a map to metadata stored in a global database for each of a plurality of metadata containers (502). Each map may be either defined statically in advance, or defined dynamically as needed. Second, the method receives information to be entered as metadata associated with a file (504). Third, the method determines which of the plurality of metadata containers is compatible with the received information (506). Finally, the method stores the information in the global database associated with the respective file using the corresponding map for the determined metadata container (508).

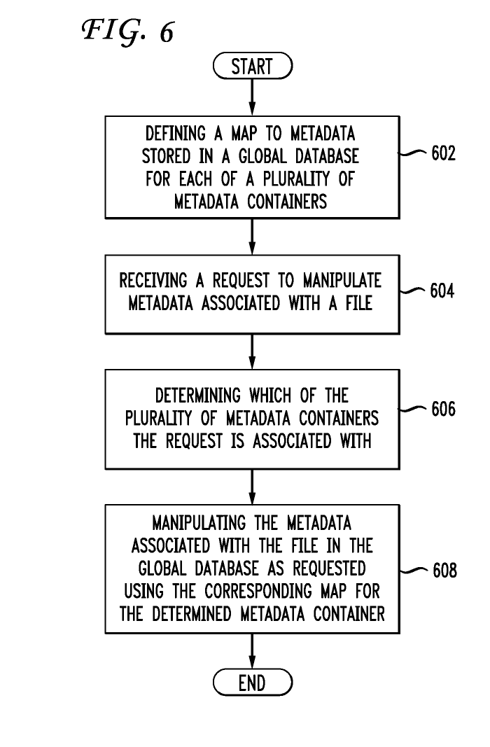

FIG. 6 illustrates a method for manipulating metadata. First, the method defines a map to metadata stored in a global database for each of a plurality of metadata containers (602). Each map may be either defined statically in advance, or defined dynamically as needed. Second, the method receives a request to modify metadata associated with a file (604). Third, the method determines which of the plurality of metadata containers the request requires (606). Finally, the method modifies the metadata in the global database as requested using the corresponding map for the determined metadata container (608).

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. For example, the invention could be applied to music notation, library systems, or automobile data bus subsystems. Accordingly, the appended claims and their legal equivalents should only define the invention, rather than any specific examples given.

I claim:

1. A method for representing metadata, the method comprising:
defining a map to metadata stored in a global database for each of a plurality of metadata containers;
receiving a query for metadata associated with a file;
determining which of the plurality of metadata containers the query requires; and
responding to the query based on metadata associated with the file from the global database retrieved using the corresponding map for the determined metadata container.

2. The method of claim 1, wherein the metadata is encrypted.

3. The method of claim 1, wherein the metadata comprises data about a plurality of files, each piece of metadata associated with its respective file.

4. The method of claim 1, wherein the global database stores metadata associated with one file.

5. The method of claim 1, wherein defining a map is done dynamically at the time of the query.

6. The method of claim 1, wherein at least one metadata container is associated with a link to a third-party database.

7. A system for representing metadata, the system comprising:
a module configured to define a map to metadata stored in a global database for each of a plurality of metadata containers;
a module configured to receive a query for metadata associated with a file;
a module configured to determine which of the plurality of metadata containers the query requires; and
a module configured to respond to the query based on metadata associated with the file from the global database retrieved using the corresponding map for the determined metadata container.

8. The system of claim 7, wherein the metadata is encrypted.

9. The system of claim 7, wherein the global database may store metadata about each of a plurality of files, each piece of metadata associated with its respective file.

10. The system of claim 7, wherein the global database stores metadata associated with one file.

11. The system of claim 7, wherein defining a map is done dynamically at the time of the query.

12. The system of claim 7, wherein at least one metadata container is associated with a link to a third-party database.

13. A computer-readable medium storing a computer program having instructions for representing metadata, the instructions comprising:
defining a map to metadata stored in a global database for each of a plurality of metadata containers;
receiving a query for metadata associated with a file;
determining which of the plurality of metadata containers the query requires; and
responding to the query based on metadata associated with the file from the global database retrieved using the corresponding map for the determined metadata container.

14. The computer-readable medium of claim 13, wherein the global database may store metadata about each of a plurality of files, each piece of metadata associated with its respective file.

15. The computer-readable medium of claim 13, wherein the global database stores metadata associated with one file.

16. The computer-readable medium of claim 13, wherein defining a map is done dynamically at the time of the query.

17. A method for storing metadata, the method comprising:
defining a map for metadata to be stored in a global database for each of a plurality of metadata containers;
receiving information to be entered as metadata associated with a file;
determining which of the plurality of metadata containers is compatible with the received information; and
storing the information in the global database associated with the respective file using the corresponding map for the determined metadata container.

18. A method for manipulating metadata, the method comprising:
defining a map to metadata stored in a global database for each of a plurality of metadata containers;
receiving a request to manipulate metadata associated with a file;
determining which of the plurality of metadata containers the request is associated with; and
manipulating the metadata associated with the file in the global database as requested using the corresponding map for the determined metadata container.

19. The method of claim 18, wherein manipulation is only performed after authenticating the request or at least one requester.

20. The method of claim 18, wherein defining a map is done dynamically at the time of receiving the request.

21. A system for manipulating metadata, the system comprising:
a module configured to define a map to metadata stored in a global database for each of a plurality of metadata containers;
a module configured to receive a request to manipulate metadata associated with a file;
a module configured to determine which of the plurality of metadata containers the request is associated with; and
a module configured to manipulate the metadata associated with the file in the global database as requested using the corresponding map for the determined metadata container.

22. The system of claim 19, wherein the module configured to define a map defines the map dynamically at the time of receiving the request.
